(19) United States
(12) Patent Application Publication
(10) Pub. No.: US 2014/0213165 A1
(43) Pub. Date: Jul. 31, 2014

(54) MOTOR VEHICLE DEFROST SYSTEM

(71) Applicant: VISTEON GLOBAL TECHNOLOGIES, INC., Van Buren Twp., MI (US)

(72) Inventors: Lakhi Nandlal Goenka, Ann Arbor, MI (US); Eric Keith Haupt, Livonia, MI (US); Heidi Crandall, Northville, MI (US)

(73) Assignee: VISTEON GLOBAL TECHNOLOGIES, INC., Van Buren Twp., MI (US)

(21) Appl. No.: 13/755,288

(22) Filed: Jan. 31, 2013

(51) Int. Cl. B60S 1/54

(52) U.S. Cl. CPC B60S 1/54
USPC 454/127; 454/121

(57) ABSTRACT

A defrost system for a motor vehicle is disclosed, the defrost system including ducting in fluid communication with a top of a windshield of the motor vehicle and/or at least one side of the windshield of the motor vehicle. In certain embodiments, the ducting has at least a portion disposed in an A-pillar of the motor vehicle, and in other embodiments the ducting has at least a portion disposed in a B-pillar of the motor vehicle.

### FIELD OF THE INVENTION

The present disclosure relates to a motor vehicle defrost system, and more particularly to a windshield motor vehicle defrost system.

### BACKGROUND OF THE INVENTION

Generally, a defrost system blows heated air on a windshield of a motor vehicle to remove frost and moisture on the windshield so that a driver can see clearly for safe driving. Defrost systems for automobiles typically include one or more diffuser outlets disposed in an instrument panel of the motor vehicle. Heated air from a heating unit is caused to flow through the diffuser outlet(s) and is uniformly diffused and dispersed along a bottom of the windshield. The diffuser and outlets occupy a considerable amount of space in the instrument panel and on the dashboard of the motor vehicle. With the size of vehicles being minimized to increase fuel economy, and due to the encroachment of other components in the instrument panel such as driver and passenger air bags, packaging space in the instrument panel and on the dashboard is at a premium.

In addition to packaging concerns, typical defrost systems cause heated air to flow from the instrument panel along a bottom of the windshield. Thus, the windshield is heated and defrosted from the bottom of the windshield toward a top of the windshield. On the other hand, motor vehicle operators have a field of vision out of the windshield is typically in the center of the thereof, both laterally and vertically. During cold startups when the motor vehicle has been sitting for an extended period, time is required for the air flowing through the motor vehicles defrost and HVAC systems to heat up. This means the operator must wait for the air to be heated, wait for the heated air to defrost the bottom of the windshield, wait until the heated air is able to defrost the center of the windshield, and then wait until the heated air is able to defrost the top of the windshield. Once the center of the windshield is defrosted, the operator can see out of the window and safely operate the vehicle.

There remains a need for a motor vehicle defrost system occupying a minimal space that can efficiently defrost the windshield to minimize a time required until an operator can safely operate the vehicle.

### SUMMARY OF THE INVENTION

Concordant and congruous with the instant disclosure, a motor vehicle defrost system occupying a minimal space that can efficiently defrost the windshield to minimize a time required until an operator can safely operate the vehicle has surprisingly been discovered.

In an embodiment of the invention, a defrost system comprises ducting providing fluid communication between a source of air and a portion of a surface adjacent a top of a windshield of a motor vehicle.

In another embodiment of the invention, a defrost system comprises a ducting providing fluid communication between a source of air and a portion of a surface adjacent a side of a windshield of a motor vehicle.

In another embodiment of the invention, a defrost system comprises ducting providing fluid communication between a source of air, a surface adjacent a top of a windshield of a motor vehicle, and a surface adjacent a side of the windshield.

### DRAWINGS

The above, as well as other advantages of the present invention, will become readily apparent to those skilled in the art from the following detailed description of a preferred embodiment when considered in the light of the accompanying drawings in which:

FIG. 1 is a perspective view of a schematic of a defrost system and a portion of an interior of a vehicle according to an embodiment of the invention;

FIG. 2 is a perspective view of a schematic of a defrost system and a portion of an interior of a vehicle according to another embodiment of the invention;

FIG. 3 is a perspective view of a schematic of a defrost system and a portion of an interior of a vehicle according to another embodiment of the invention;

FIG. 4 is a perspective view of a schematic of an instrument panel and the defrost system within a portion of the interior of the vehicle of FIG. 3; and

FIG. 5 is a perspective view of a schematic of a defrost system and a portion of an interior of a vehicle according to another embodiment of the invention;

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

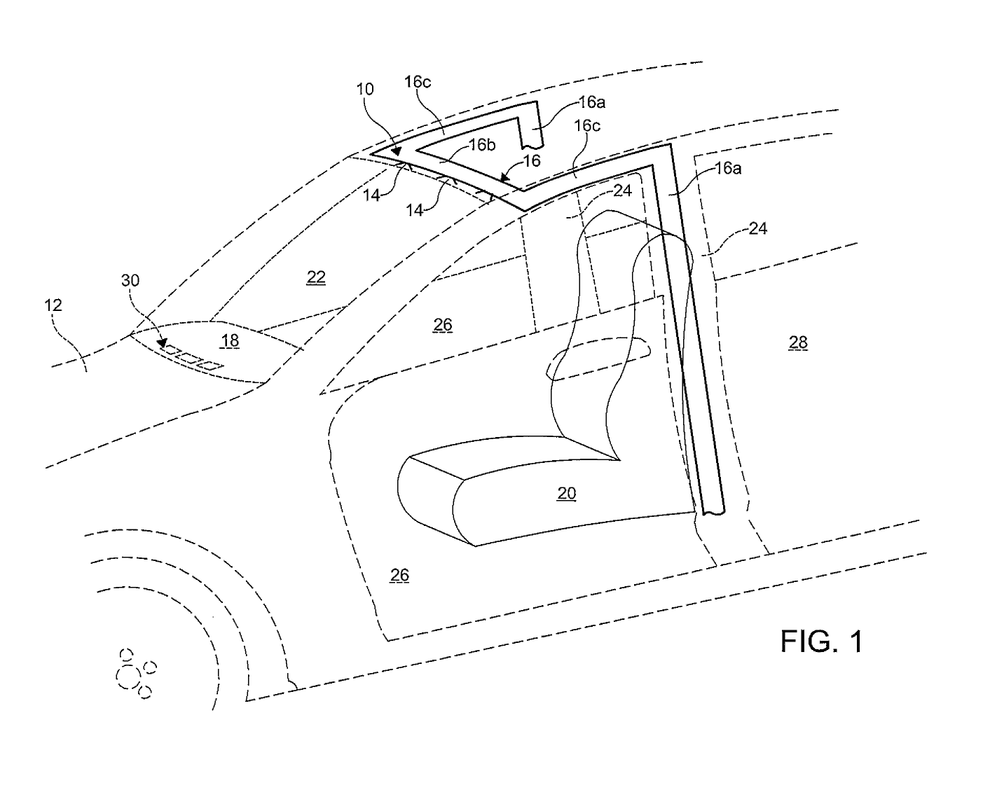

FIGS. 1-5 show various embodiments of a defrost system 10 for a motor vehicle 12 according to an embodiment of the invention. Each of the embodiments includes the defrost system 10 having a plurality of diffusers 14 and ducting 16 in fluid communication with an HVAC system (not shown) including a source of air (not shown), such as a heating element (not shown), an evaporator (not shown), or a blower assembly (not shown), for example. The source of air and/or the HVAC system may be disposed in the instrument panel 18 of the vehicle 12, under a front seat 20 or rear seat (not shown) of the vehicle, in between front seats, or in an engine compartment of the vehicle 12, as desired. Alternatively, the defrost system 10 may have its own source of air independent from the HVAC system of the vehicle 12. The ducting 16 of the embodiments shown in FIGS. 1-5 and described hereinbelow include a plurality of portions. The adjectives first, second, third, and fourth are associated with the portions to distinguish one portion from another and are not meant to connote a particular or desired order. As discussed herein, air caused to flow through defrost system 10 is noted as “heated air”. Heated air is defined as air having a temperature greater than the temperature of a windshield 22 of the vehicle 12 and/or the temperature of air on an exterior of the vehicle 12. Accordingly, the heated air may be air heated by the heating element, or the heated air may be air cooled by the evaporator to a temperature above that of the windshield 22 or the exterior air.

FIG. 1 shows the defrost system 10 according to an embodiment of the invention. The diffusers 14 of the defrost system 10 facilitate a flow of air from the ducting 16 to a top of the windshield 22 of the motor vehicle 12. The diffusers 14 are disposed in or adjacent a ceiling of the vehicle 12 and provide air to a top of the windshield 22. The ducting 16 provides air from the heating element through the defrost system 10 and to the diffusers 14. The ducting 16 includes first portions 16a, a second portion 16b, and third portions 16c. The first portions 16a are disposed in or adjacent B-pillars 24 of the vehicle 12 and provide fluid communication between the heating element and the second portion 16b. In a four-door vehicle as shown in FIG. 1, the B-pillars 24 are defined as a portion of the body of the vehicle 12 disposed between the front doors 26 and the rear doors 28 of the vehicle 12. While the defrost system 10 is shown as having ducting 16 in B-pillars 24 of the driver side and the passenger side of the vehicle 12, it is understood that the defrost system 10 may be disposed in only one B-pillar 24, as desired. In a two-door vehicle (not shown), the B-pillar 24 is defined as a portion of the body of the vehicle 12 disposed between the front door 26 and a rear window (not shown).

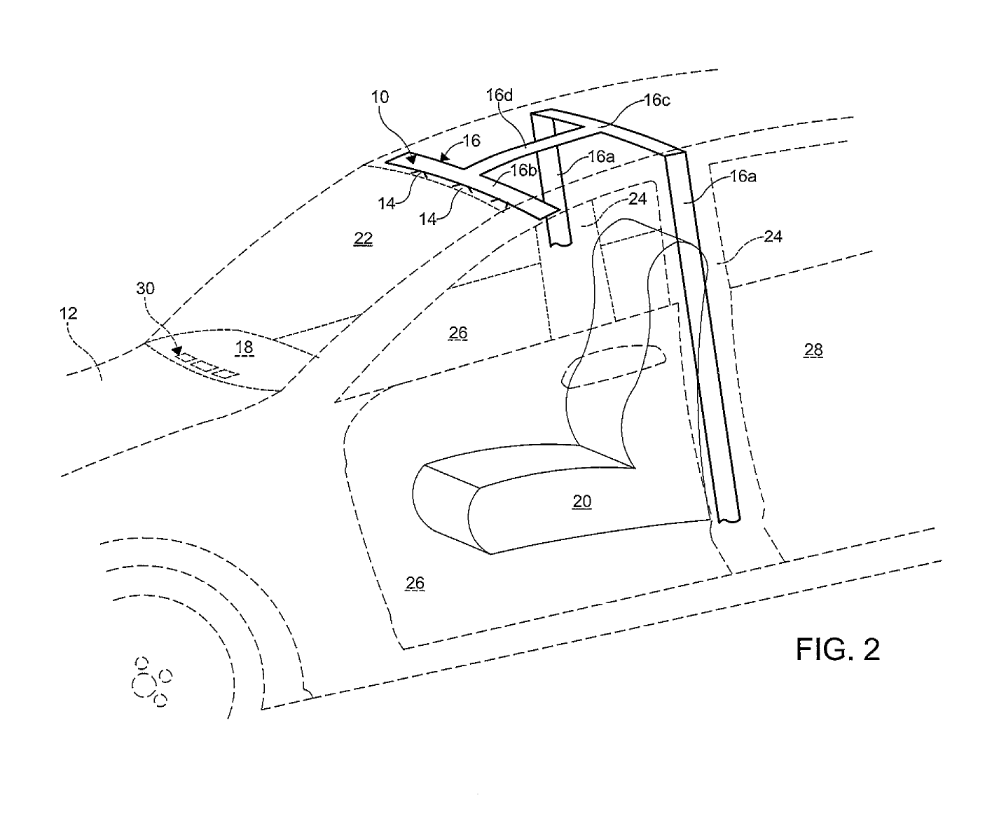

The second portion 16b of the ducting 16 is disposed in or adjacent the ceiling of the vehicle substantially parallel to and adjacent the top edge of the windshield 22. The second portion 16b includes apertures in fluid communication with the diffusers 14. While three diffusers 14 are shown in FIG. 1, any number of diffusers 14 may be used to provide air to a larger or a smaller area of the windshield 22, as desired. As shown, fluid communication is provided between the first portions 16a and the second portion 16b by the third portions 16c of the ducting 16. As shown, the third portions 16c are disposed in or adjacent the ceiling of the vehicle 12 above the front doors 26. As best shown in FIG. 2, the third portion 16c may cross the ceiling above the front seat 20 to provide communication to a portion 16d of the ducting 16 substantially perpendicular to a top of the windshield 22 in fluid communication with the second portion 16b or additional ducting (not shown), as desired. In the embodiment of FIG. 2, the second portion 16b may be a length shorter than a width of the top of the windshield 22, as desired.

In use, air is caused to flow from the heating element to and through the first portions 16a of the ducting 16 in the B-pillars 24, through the third portions 16c, and through the second portion 16b. The air flows through the diffusers 14 of the second portion 16b and onto a surface adjacent the top of the windshield 22 causing the windshield 22 to defrost from the top thereof down toward the instrument panel 18.

Since a typical operator of the vehicle 12 has a sightline closer to the top of the windshield 22 than to a bottom of the windshield 22, the defrost system 10 defrosts the windshield 22 and provides a viewable area in the sightline of the user faster than a standard “bottom-up” defrost system 30 would. The defrost system 30 defrosts the windshield 22 from the bottom thereof, requiring a majority of the windshield 22 to be defrosted before a viewable area in the sightline near a top of the windshield 22. As shown in FIG. 1, the defrost system 10 may be used in conjunction with the defrost system 30 to defrost the windshield 22 simultaneously from the top and the bottom. The defrost system 30 may be a system independent from the defrost system 10 with its own heating element. However, the defrost system 30 may be part of the defrost system 10 with ducting (not shown) disposed along the bottom of the windshield 22 or in the instrument panel 18 adjacent the bottom of the windshield 22 in fluid communication with the ducting 16.

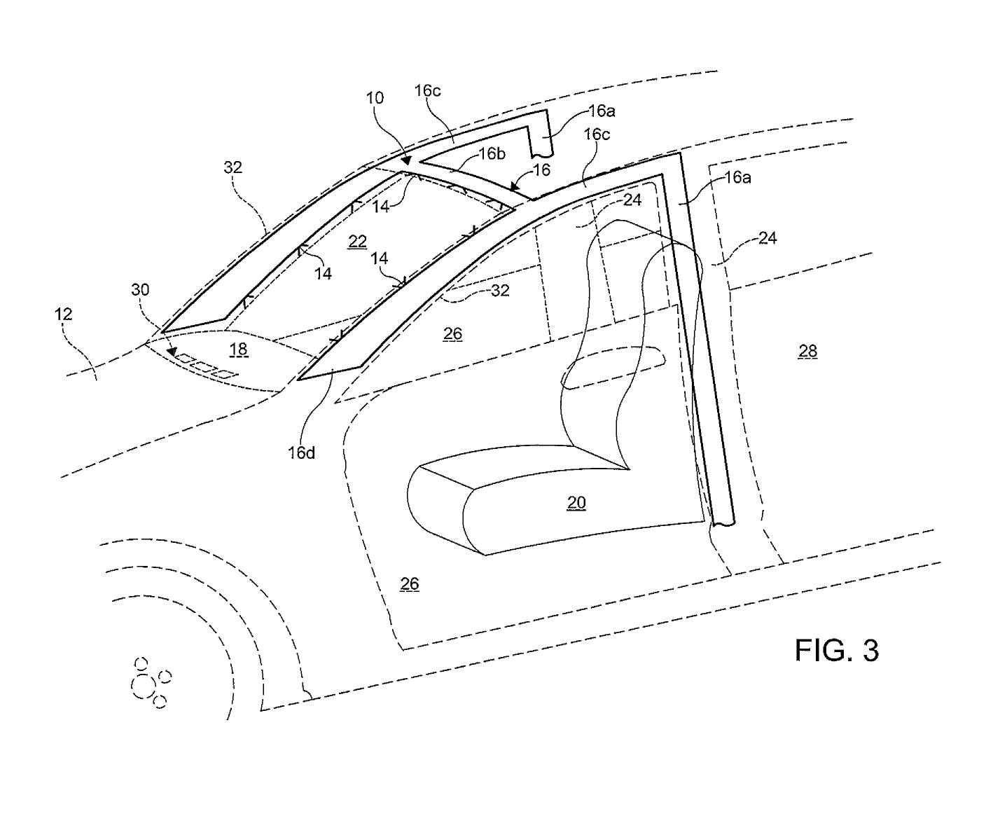

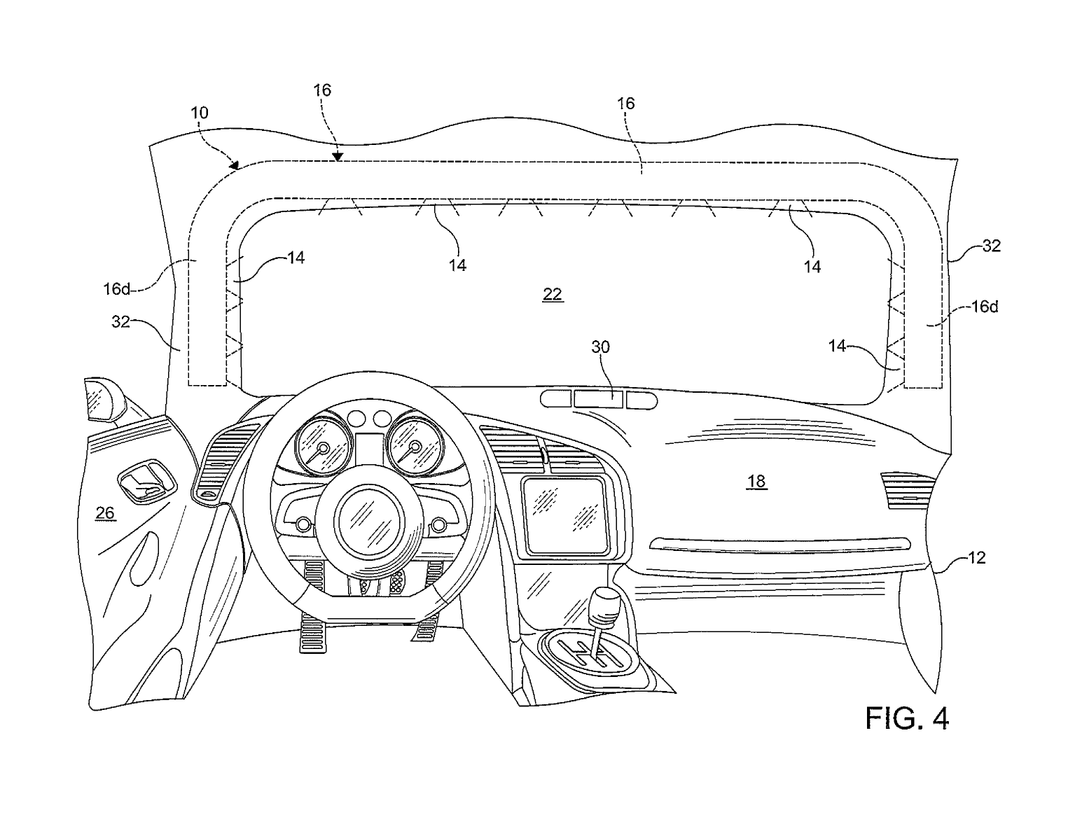

FIGS. 3 and 4 show a defrost system 10 according to another embodiment of the invention. The defrost system 10 is similar to the defrost system 10 shown in FIG. 1, except as described hereinbelow. A plurality of diffusers 14 of the defrost system 10 facilitate a flow of air from the ducting 16 to the top and each side of a windshield 22 of a motor vehicle 12. Diffusers 14 disposed in a ceiling of the vehicle 12 provide air to the top of the windshield 22, while diffusers 14 disposed in the A-pillars 32 of the vehicle 12 provide air to each of the sides of the windshield 22.

The ducting 16 provides air from the heating element through the defrost system 10 and to the diffusers 14. The ducting 16 includes first portions 16a, a second portion 16b, third portions 16c, and fourth portions 16d. The first portions 16a are disposed in or adjacent the B-pillars 24 of the vehicle 12 and provide fluid communication between the heating element and the second portion 16b. The second portion 16b of the ducting 16 is disposed in the ceiling of the vehicle substantially parallel to and adjacent the top edge of the windshield 22. The second portion 16b includes apertures in fluid communication with the diffusers 14. While three diffusers 14 are shown in the second portion 16b of FIG. 3 and six diffusers 14 are shown in the second portion 16b of FIG. 4, any number of diffusers 14 may be used to provide air to a larger or a smaller area of the top of the windshield 22, as desired. The fourth portions 16d of the ducting 16 are disposed in or adjacent the A-pillars 32 of the vehicle. The fourth portions 16d may have a length substantially equal to a length of the sides of the windshield 22, or the fourth portions 16d may have a length less than a length of the sides of the windshield 22. The fourth portions 16d include apertures in fluid communication with the diffusers 14. While three diffusers 14 are shown in each of the fourth portions 16d of FIGS. 3 and 4, any number of diffusers 14 may be used to provide air to a larger or a smaller area of each side of the windshield 22, as desired. The fourth portions 16d are in direct fluid communication with the third portions 16c and the second portion 16b. As shown in FIGS. 3 and 4, the A-pillars 32 are defined as a portion of the body of the vehicle 12 disposed between the front doors 26 and the windshield 22 of the vehicle 12. While the defrost system 10 is shown as having ducting 16 in both A-pillars 32 and both B-pillars 24 of the vehicle 12, it is understood that the defrost system 10 may be disposed in only one B-pillar 24 and only one A-pillar 32, as desired. Fluid communication is provided between the first portions 16a, the second portion 16b, and the fourth portions 16d by the third portions 16c of the ducting 16. As shown, the third portion 16c is disposed in or adjacent the ceiling of the vehicle 12 above the front door 26. It is understood that the third portion 16c may cross the ceiling above the front seat 20 to provide communication to ducting substantially perpendicular to a top of the windshield 22 or additional ducting (not shown), as desired.

In use, air is caused to flow from the heating element to and through the first portions 16a of the ducting 16 in the B-pillars 24, through the third portions 16c, and simultaneously through the fourth potions 16d and the second portion 16b. It is understood that a valve or other flow restrictor or disruptor may be disposed between the fourth portions 16d and the second portion 16b to selectively facilitate flow to the fourth portions 16d. The air flows through the diffusers 14 of the second portion 16b and onto a surface adjacent the top of the windshield 22 causing the windshield 22 to defrost from the top thereof down toward the instrument panel 18, while air flows through the diffusers 14 of the fourth portions 16d and onto a surface adjacent each of the sides of windshield 22 causing the windshield 22 to defrost from each side thereof toward a center thereof.

Since a typical operator of the vehicle 12 has a sightline closer to the top of the windshield 22 than to a bottom of the windshield 22, the defrost system 10 defrosts the windshield 22 and provides a viewable area in the sightline of the user faster than a standard “bottom-up” defrost system 30 would. The defrost system 10 defrosts the windshield 22 both from the bottom and each side thereof, thereby defrosting nearly an entire viewable area of the operator to facilitate safe operation of the vehicle. As shown in FIGS. 3 and 4, the defrost system 10 may be used in conjunction with the defrost system 30 to defrost the windshield 22 simultaneously from the top, the sides, and the bottom. The defrost system 30 may be a system independent from the defrost system 10 with its own heating element. However, the defrost system 30 may be part of the defrost system 10 with ducting (not shown) disposed along the bottom of the windshield 22 or in the instrument panel 18 adjacent the bottom of the windshield 22 in fluid communication with the ducting 16.

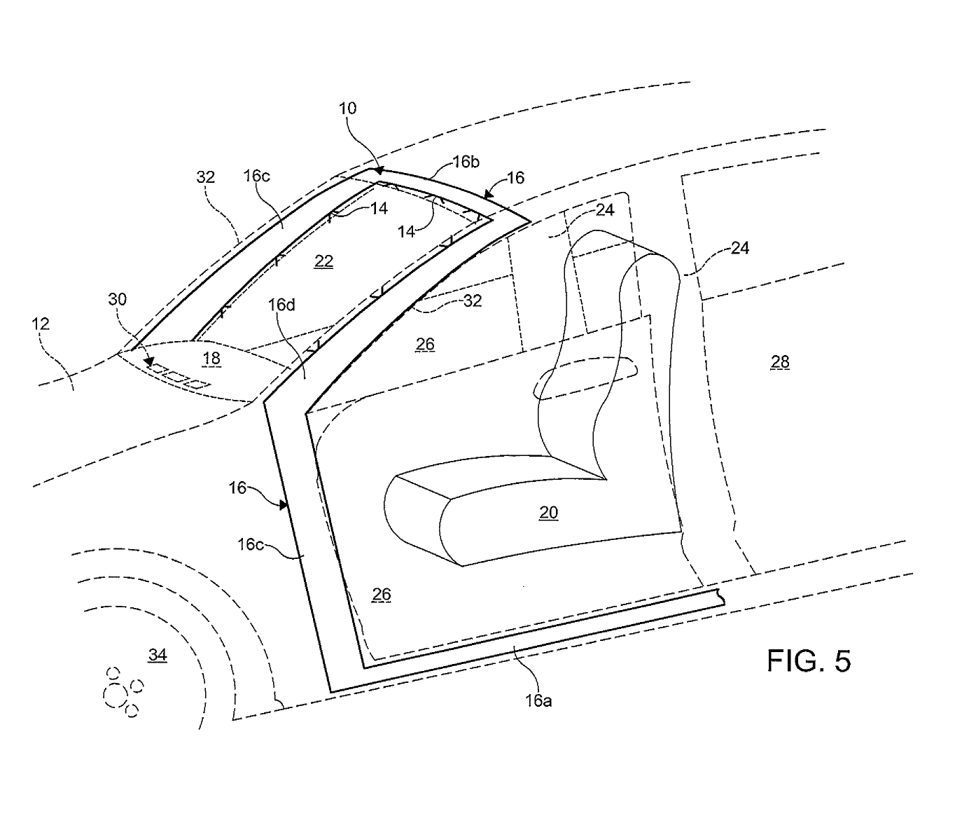

FIG. 5 shows a defrost system 10 according to another embodiment of the invention. The defrost system 10 is similar to the defrost systems 10 shown in FIGS. 1-3, except as described hereinbelow. A plurality of diffusers 14 of the defrost system 10 facilitate a flow of air from ducting 16 to the top and each side of a windshield 22 of a motor vehicle 12. Diffusers 14 disposed in or adjacent a ceiling of the vehicle 12 provide air to the top of the windshield 22, while diffusers 14 disposed in the A-pillars 32 of the vehicle 12 provide air to each of the sides of the windshield 22. The ducting 16 provides air from the heating element through the defrost system 10 and to the diffusers 14. The ducting 16 includes first portions 16a, a second portion 16b, third portions 16c, and fourth portions 16d. Only the first portion 16a on the driverside of the vehicle 12 is shown in FIG. 5, but a corresponding first portion 16a is disposed on the passenger side of the vehicle. The first portions 16a are disposed between a floorboard of the vehicle 12 and a bottom of the front door 26. It is understood that the first portion 16a may be disposed immediately adjacent the front door 26, as shown in FIG. 5, or beneath the front seat 20, as desired. The first portions 16a provide fluid communication between the heating element and the remainder of the ducting 16.

The second portion 16b of the ducting 16 is disposed in the ceiling of the vehicle substantially parallel to and adjacent the top edge of the windshield 22. The second portion 16b includes apertures in fluid communication with the diffusers 14. While three diffusers 14 are shown in the second portion 16b of FIG. 5, any number of diffusers 14 may be used to provide air to a larger or a smaller area of the top of the windshield 22, as desired. The fourth portions 16d of the ducting 16 are disposed in or adjacent the A-pillars 32 of the vehicle. The fourth portions 16d include apertures in fluid communication with the diffusers 14. While three diffusers 14 are shown in each of the fourth portions 16d of FIG. 5, any number of diffusers 14 may be used to provide air to a larger or a smaller area of each side of the windshield 22, as desired. The fourth portions 16d are in direct fluid communication with the third portions 16c and the second portion 16b. While the defrost system 10 is shown as having ducting 16 in both A-pillars 32 of the vehicle 12, it is understood that the defrost system 10 may be disposed in only one A-pillar 32, as desired. As shown, fluid communication is provided between the first portions 16a, the second portion 16b, and the fourth portions 16d by the third portions 16c of the ducting 16. As shown, the third portion 16c is disposed in a portion of the vehicle 12 between a front tire 34 and the front door 26. It is understood that the third portion 16c may be partially or completely disposed within an engine compartment (not shown) at a front of the vehicle 12, as desired.

In use, air is caused to flow from the heating element to and through the first portions 16a of the ducting 16, through the third portions 16c, through the fourth portions 16d in the A-pillars 32, through the second portion 16b. It is understood that a valve or other flow restrictor or disruptor may be disposed between the fourth portions 16d and the second portion 16b to selectively facilitate flow to the second portion 16b. The air flows through the diffusers 14 of the second portion 16b and onto a surface adjacent the top of the windshield 22 causing the windshield 22 to defrost from the top thereof down toward the instrument panel 18, while air flows through the diffusers 14 of the fourth portions 16d and onto a surface adjacent each of the sides of windshield 22 causing the windshield 22 to defrost from each side thereof toward a center thereof.

Since a typical operator of the vehicle 12 has a sightline closer to the top of the windshield 22 than to a bottom of the windshield 22, the defrost system 10 defrosts the windshield 22 and provides a viewable area in the sightline of the user faster than a standard “bottom-up” defrost system 30 would. The defrost system 10 defrosts the windshield 22 both from the bottom and each side thereof, thereby defrosting nearly an entire viewable area of the operator to facilitate safe operation of the vehicle. As shown in FIG. 5, the defrost system 10 may be used in conjunction with the defrost system 30 to defrost the windshield 22 simultaneously from the top, the sides, and the bottom. The defrost system 30 may be a system independent from the defrost system 10 with its own heating element. However, the defrost system 30 may be part of the defrost system 10 with ducting (not shown) disposed along the bottom of the windshield 22 or in the instrument panel 18 adjacent the bottom of the windshield 22 in fluid communication with the ducting 16.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A defrost system comprising:
ducting providing fluid communication between a source of air and a portion of a surface adjacent a top of a windshield of a motor vehicle.

2. The defrost system of claim 1, wherein the ducting includes a first portion disposed in or adjacent to at least one B-pillar of the motor vehicle, the first portion providing fluid communication between the source of air and the portion of the surface adjacent the top of the windshield.

3. The defrost system of claim 2, wherein the ducting includes a second portion disposed in or adjacent to a ceiling of the motor vehicle substantially parallel to the top edge of the windshield, the second portion in fluid communication with the first portion and the source of air.

4. The defrost system of claim 3, wherein the second portion has a length substantially equal to or less than a width of the top of the windshield.

5. The defrost system of claim 3, wherein the ducting includes a third portion disposed in or adjacent the ceiling above at least a portion of one front door of the motor vehicle, the third portion providing fluid communication between the first portion and the second portion.

6. The defrost system of claim 5, wherein the ducting includes a fourth portion disposed in an A-pillar of the motor vehicle, the fourth portion providing fluid communication between the third portion and at least one surface adjacent a side of the windshield.

7. The defrost system of claim 1, wherein the ducting includes a first portion disposed between a floorboard and a front door of the motor vehicle, the first portion providing fluid communication between the source of air and the the portion of the surface adjacent the top of the windshield.

8. The defrost system of claim 7, wherein the ducting includes a second portion disposed in or adjacent to a ceiling of the motor vehicle substantially parallel to the top edge of the windshield, the second portion in fluid communication with the first portion and the source of air.

9. The defrost system of claim 8, wherein the ducting includes a third portion disposed between a front tire and a front door of the motor vehicle, the third portion providing fluid communication between the first portion and the second portion.

10. The defrost system of claim 9, wherein the ducting includes a fourth portion disposed in at least one A-pillar of the motor vehicle, the fourth portion providing fluid communication between the second portion and the third portion.

11. A defrost system comprising:
ducting providing fluid communication between a source of air and a portion of a surface adjacent a side of a windshield of a motor vehicle.

12. The defrost system of claim 11, wherein the ducting includes a first portion disposed in or adjacent to at least one B-pillar of the motor vehicle, the first portion providing fluid communication between the source of air and the portion of the surface adjacent the side of the windshield.

13. The defrost system of claim 12, wherein the ducting includes a second portion disposed in or adjacent to a ceiling of the motor vehicle substantially parallel to the top edge of the windshield, the second portion in fluid communication with the first portion and the source of air.

14. The defrost system of claim 13, wherein the ducting includes a third portion disposed in or adjacent the ceiling above at least a portion of one front door of the motor vehicle, the third portion providing fluid communication between the first portion and the second portion.

15. The defrost system of claim 14, wherein the ducting includes a fourth portion disposed in an A-pillar of the motor vehicle, the fourth portion providing fluid communication between the third portion and the surface adjacent the side of the windshield.

16. The defrost system of claim 11, wherein the ducting includes a first portion disposed between a floorboard and a front door of the motor vehicle, the first portion providing fluid communication between the source of air and the portion of the surface adjacent the side of the windshield.

17. The defrost system of claim 16, wherein the ducting includes a second portion disposed in or adjacent to a ceiling of the motor vehicle substantially parallel to the top edge of the windshield, the second portion in fluid communication with the first portion and the source of air.

18. The defrost system of claim 17, wherein the ducting includes a third portion disposed between a front tire and a front door of the motor vehicle, the third portion providing fluid communication between the first portion and the second portion.

19. The defrost system of claim 18, wherein the ducting includes a fourth portion disposed in at least one A-pillar of the motor vehicle, the fourth portion providing fluid communication between the second portion and the third portion.

20. A defrost system comprising:
ducting providing fluid communication between a source of air, a surface adjacent a top of a windshield of a motor vehicle, and a surface adjacent a side of the windshield.
